(19) United States
(12) Patent Application Publication
(10) Pub. No.: US 2015/0248454 A1
(43) Pub. Date: Sep. 3, 2015

(54) QUERY SIMILARITY-DEGREE EVALUATION SYSTEM, EVALUATION METHOD, AND PROGRAM

(71) Applicant: NEC CORPORATION, Minato-ku, Tokyo (JP)

(72) Inventors: Yusuke Muraoka, Tokyo (JP); Yukitaka Kusumura, Tokyo (JP); Hironori Mizuguchi, Tokyo (JP); Dai Kusui, Tokyo (JP)

(73) Assignee: NEC Corporation, Minato-ku, Tokyo (JP)

(21) Appl. No.: 14/430,292

(22) PCT Filed: Sep. 12, 2013
(86) PCT No.: PCT/JP2013/005406

§ 371 Date: Mar. 23, 2015

(30) Foreign Application Priority Data
Sep. 28, 2012 (JP) 2012-217118

(51) Int. Cl. G06F 17/30

(52) U.S. Cl. CPC G06F 17/30395; G06F 17/30864; G06F 17/3053

(57) ABSTRACT

[Problem] Since similarity of queries is determined on the basis of similarity of documents that are not related to a search intention, queries whose search intention is similar to each other cannot be determined.

[Solution Means] A search result ranking means and a query similarity-degree calculating means are provided. The search result ranking means determines a first weight degree of each of a plurality of documents on the basis of respective evaluation results of the plurality of documents that have been retrieved by a first query, and determines a second weight degree of each of a plurality of documents on the basis of respective evaluation results of the plurality of documents that have been retrieved by a second query. The query similarity-degree calculating means calculates a similarity degree of two search results to which importance have been given, such that the similarity degree becomes larger as the documents of higher importance are similar to each other. Thereby, a similarity degree of documents in a case of the same search intention is calculated so that the problem can be solved.

### TECHNICAL FIELD

The present invention relates to a query similarity-degree evaluation system, an evaluation method, a program, and a storage medium.

### BACKGROUND ART

In a searching system, it is important for a user to find a target document promptly. Description contents that a searching person searches for, e.g. “want to know a setting method for a memory size in mysql” or “want to know a method of increasing a searching speed in mysql”, are called as a search intention herein.

When a user inputs a query, in a case of searching for a document including a content satisfying a search intention, it is useful that a searching system recommends, to a user, a query similar to the search intention of the user, and ranking to documents (referred to as “search result documents” in the following) of a result of searching such that a target document comes to be at a high rank by a query having a similar search intention is useful. A searching system can prevent searching missing by displaying not only a result of an input query, but also a result of a query having a similar search intention.

When a user searches for a document including a content satisfying a search intention, using a log of access to documents at the past searching time or an evaluation log enables a searching system to improve ranking to search result documents. However, in some cases, the above-mentioned logs do not exist sufficiently for all of queries. For a query for which the logs are not sufficient, using not only the log of this query but also the log of a query having a similar search intention enables ranking of search result documents to be improved for more queries.

For such application, it is necessary to determine a query having a similar search intention. As a method for determining whether or not search intention is similar for a plurality of queries, there is known a method of using search result documents of respective queries. One example of a system that uses search result documents to determine a query representing a similar search intention is described in the non-patent literature (NPL) 1.

As illustrated in FIG. 11, a query similarity-degree determining system described in NPL 1 includes search result acquisition means for acquiring respective search results of queries (query 1 and query 2) of which similarity-degrees are sought to be evaluated, and search result similarity-degree calculation means for calculating a similarity-degree of the search results. A conventional query similarity-degree determining system having such a configuration operates as follows.

First, the search result acquisition means acquires respective search result documents of two input queries from a search target document storing unit. Next, the two groups of the search result documents acquired by the search result acquisition means are set as input, the search result similarity-degree calculation means calculates and outputs, on the basis of coincidence of the search result documents or coincidence of words included in the search result documents, a similarity-degree that becomes larger as the coincident number becomes larger.

### CITATION LIST

### Non Patent Literature

NPL 1: “Finding similar queries to satisfy searches based on query traces”, Zaiane, O. and Strilets, A., Advances in Object-Oriented Information Systems, (2002)

### SUMMARY OF INVENTION

### Technical Problem

However, since the query similarity-degree determining system described in NPL 1 mentioned above calculates a similarity degree between documents of search results obtained from queries, a following problem exists. The problem is that the query similarity-degree determining system described in NPL 1 erroneously determines that queries are similar to each other by coincidence between a document that has not been read and a document that does not go along with a search intention. As a result of it, queries of which search intention is not similar to each other are improperly determined to be similar to each other, which is a problem. In other words, in the query similarity-degree determining system described in NPL 1, accuracy in determination of a similarity-degree of queries is low, and there is room for improvement.

In view of the above, one example of objects of the present invention is to provide a query similarity-degree evaluation system, an evaluation method, and a program for determining whether or not search intention of a plurality of input queries is similar to each other with high accuracy.

### Solution to Problem

In order to accomplish the above-described object, a query similarity-degree evaluation system according to one exemplary embodiment of the present invention includes: a search result ranking means for determining a first importance of each of a plurality of documents on the basis of respective evaluation results of the plurality of documents that have been retrieved by a first query, and determining a second importance of each of a plurality of documents on the basis of respective evaluation results of the plurality of documents that have been retrieved by a second query; and a query similarity-degree calculation means for calculating a similarity-degree of the queries on the basis of the first and second importance of the respective documents of the document sets.

Further, in order to accomplish the above-described object, a query similarity-degree evaluation method according to one exemplary embodiment of the present invention includes: a search result ranking step of determining a first importance of each of a plurality of documents on the basis of respective evaluation results of the plurality of documents that have been retrieved by a first query, and determining a second importance of each of a plurality of documents on the basis of respective evaluation results of the plurality of documents that have been retrieved by a second query; and a query similarity-degree calculation step of calculating a similarity-degree of the queries on the basis of the first and second importance of the respective documents of the document sets.

Furthermore, in order to accomplish the above-described object, a program according to one exemplary embodiment of the present invention causes a computer to: determine a first importance of each of a plurality of documents on the basis of respective evaluation results of the plurality of documents that have been retrieved by a first query, and determine a second importance of each of a plurality of documents on the basis of respective evaluation results of the plurality of documents that have been retrieved by a second query; and function as a query similarity-degree calculation step of calculating a similarity-degree of the queries on the basis of the first and second importance of the respective documents of the document sets.

### Advantageous Effects of Invention

As described above, according to the query evaluation system, the query evaluation method, and the program of the present invention, queries whose search intention is similar to each other can be specified with high accuracy.

### BRIEF DESCRIPTION OF DRAWINGS

FIG. 1 is a block diagram illustrating a configuration of the exemplary embodiment of the present invention.

FIG. 2 is a flowchart representing the best operation for embodying the present invention.

FIG. 3 is a block diagram illustrating one example of a computer that implements a configuration of the exemplary embodiment of the present invention.

FIG. 4 illustrates a concrete example of data for a search target document storing unit 31.

FIG. 5 illustrates a concrete example of data for a query evaluation record storing unit 32.

FIG. 6 illustrates a concrete example of output from a search result acquisition unit 21.

FIG. 7 illustrates a concrete example of output from the search result acquisition unit 21.

FIG. 8 illustrates a concrete example of output from a search result ranking unit 22.

FIG. 9 illustrates a concrete example of output from the search result ranking unit 22.

FIG. 10 illustrates an example of data stored by the query evaluation record storing unit 32.

FIG. 11 is a block diagram of the prior art.

### DESCRIPTION OF EMBODIMENTS

The exemplary embodiment of the invention is described in detail with reference to the drawings.

The term “evaluation” used in the present application represents, among acts taken by a user of a search engine, an act that is a hint for determining whether or not the user sought a document. Evaluation means, for example, (1) evaluation that concerns documents registered in a searching system and that is based on a result of a questionnaire, given to the user, of whether or not the document was useful in searching, or (2) access to a document at the time of searching. The action that an answer in the questionnaire or the evaluation is given as “useful”, and the action that a document is accessed by a user are hints indicating that the document is sought, and both actions are regarded as high evaluation. On the contrary, the action that an answer is given as “not useful”, and the action that a document is not accessed by a user though the document link is displayed on a screen are hints indicating that the document is not sought, and both actions are regarded as low evaluation.

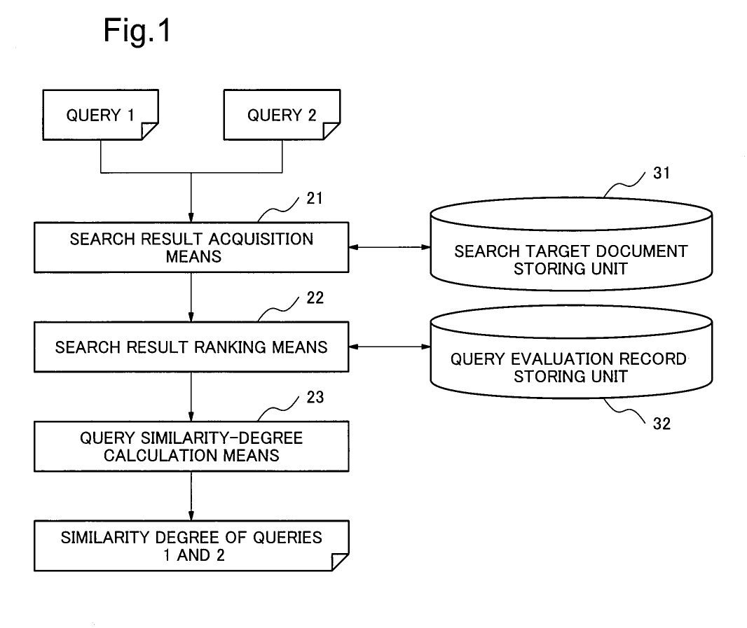

By using FIG. 1, a configuration of a query similarity-degree evaluation system according to the exemplary embodiment of the present invention is described. FIG. 1 is a block diagram illustrating the configuration of the exemplary embodiment of the present invention.

Referring to FIG. 1, the query similarity-degree evaluation system in the exemplary embodiment of the present invention includes a search result acquisition unit 21, a search result ranking unit 22, a query similarity-degree calculation unit 23, a search target document storing unit 31, and a query evaluation record storing unit 32.

The search target document storing unit 31 stores documents that are search targets in the searching system. For example, the search target document storing unit 31 stores document texts themselves, metadata (document IDs, update date and time of documents, authors, texts to which specific tags are given, IDs of documents for referring to documents, scores given to documents, and the like) given to a document, inverted indexes given to words in document texts, and the like.

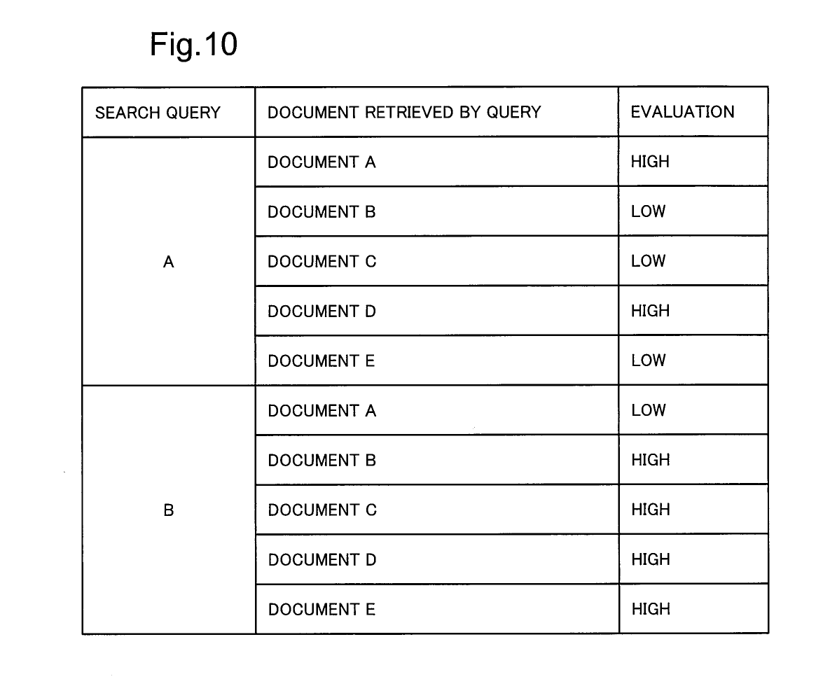

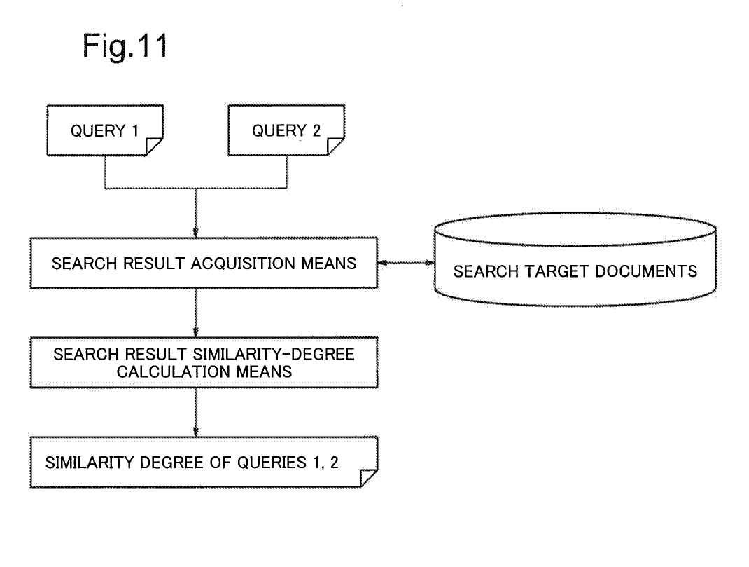

The query evaluation record storing unit 32 stores information in which queries and records of evaluation of the queries (referred to as “evaluation records” in the following) are related to each other. For example, as illustrated in FIG. 10, the query evaluation record storing unit 32 records information in which queries input to a search engine in the past by a user (referred to as “queries” in the following), documents retrieved by the queries concerned, and evaluations of the documents concerned are related to each other. Data stored in the query evaluation record storing unit 32, which are created by outputting a log describing a query and an accessed document at the searching system, may be stored in advance.

Next, operation of the query similarity-degree evaluation system in the exemplary embodiment of the present invention is described.

The search result acquisition unit 21 refers to the search target document storing unit 31, and specifies respective search results for two queries (a first query and a second query). For example, the search result acquisition unit 21 specifies documents including search queries. The search result acquisition unit 21 outputs sets (referred to as “search result document sets” or “a search result document set 1 and a search result set 2” in the following) of the two specified search result documents to the search result ranking unit 22. For a set of the two queries that are output by the search result acquisition unit 21 and the two search result document sets that respectively correspond to the two queries, the search result ranking unit 22 refers to the query evaluation record storing unit 32 to examine whether or not evaluation records for the queries are included. When none of the evaluation records are included in the query evaluation record storing unit 32, the search result ranking unit 22 calculates a importance for each document of the two search result document sets on the basis of ranking scores (e.g., the number of times that a query word is included, or a document score of PageRank or the like) calculated from only the search result documents and the queries, and outputs the calculated importance to the query similarity-degree calculation unit 23.

When any one of the evaluation records is included in the query evaluation record storing unit 32, the search result ranking unit 22 refers to the query evaluation record storing unit 32. The search result ranking unit 22 calculates a importance for each document of the two search result document sets on the basis of a result of the referring. For example, the search result ranking unit 22 calculates such that a importance becomes higher as an evaluation of a document corresponding to the query becomes high, and a importance becomes lower as an evaluation of a document becomes lower. The search result ranking unit 22 outputs the calculated result to the query similarity-degree calculation unit 23.

For example, a method (referred to as “importance calculating method” in the following) for calculating a importance described above may be a method of specifying a word (characteristic word) of which appearance frequency is high in a document evaluated high, and is low in a document evaluated low, and calculating, for a document desired to be rearranged, a importance that becomes higher as a frequency of the above-specified word is larger.

Alternatively, for example, a importance calculating method may be a method of calculating, for a group of queries and documents, an Euclid distance between a characteristic vector of an input document and a characteristic vector of a document evaluated high with a characteristic vector being set as appearance frequencies of query keywords in a document, or as values of metadata (updated date and time of the document, a length of the document, and the like) given to the document, and calculating a importance that becomes higher as the distance becomes smaller.

If both of the evaluation records are included in the query evaluation record storing unit 32, the search result ranking unit 22 refers to the query evaluation record storing unit 32 for the respective queries. The search result ranking unit 22 rearranges the two search result document sets such that a document that corresponds to the query and that has been evaluated is made to be at a high rank, and a document that has not been evaluated is made to be at a low rank, on the basis of a result of the referring. The search result ranking unit 22 outputs, to the query similarity-degree calculation unit 23, the two groups of the two search result document sets obtained by the respective rearrangement.

For one or two groups of the rearranged search result document sets output from the search result ranking unit 22, the query similarity-degree calculation unit 23 calculates a similarity degree between the search result document sets so as to place great importance on similarity between documents for which high importance have been calculated in the respective documents.

$${\sum }_{{d}_{1} ∈ {S}_{1}} {\sum }_{{d}_{2} ∈ {S}_{2}} {w}_{1} ( {d}_{1} ) {w}_{2} ( {d}_{2} ) sim ( {d}_{1} , {d}_{2} ) \qquad [ Equation 1 ]$$

In the equation 1, the search result set 1 is represented by S₁, the search result set 2 is represented by S₂, a importance of a document d₁ in the search result set 1 is represented by the w₁(d₁), a importance of a document d₂ in the search result set 2 is represented by the w₂(d₂), and a similarity degree of the document d₁ and the document d₂ is represented by sim(d₁, d₂).

The equation 1 sums up similarity degrees while placing a larger weight on a similarity degree for each combination of documents included in the search result set 1 and the search result set 2 as a product of a importance in the search result set 1 and a importance in the search result set 2 becomes larger. When the two groups are input, for the equation 1, an average of values calculated for the respective groups is used.

Particularly, when sim(d₁, d₂) is determined by coincidence of the documents, a similarity degree is calculated by the following equation.

$${\sum }_{d ∈ {S}_{1} ⋂ {S}_{2}} {w}_{1} ( d ) {w}_{2} ( d ) \qquad [ Equation 2 ]$$

The query similarity-degree calculation unit 23 determines a document similarity degree by coincidence of IDs of the documents in the equation 2, but may determine it by similarity of document contents. For example, the query similarity-degree calculation unit 23 may use a cosine similarity of word vectors of document texts, or a norm of differences of metadata.

### [Operation of Query Similarity-Degree Evaluation System]

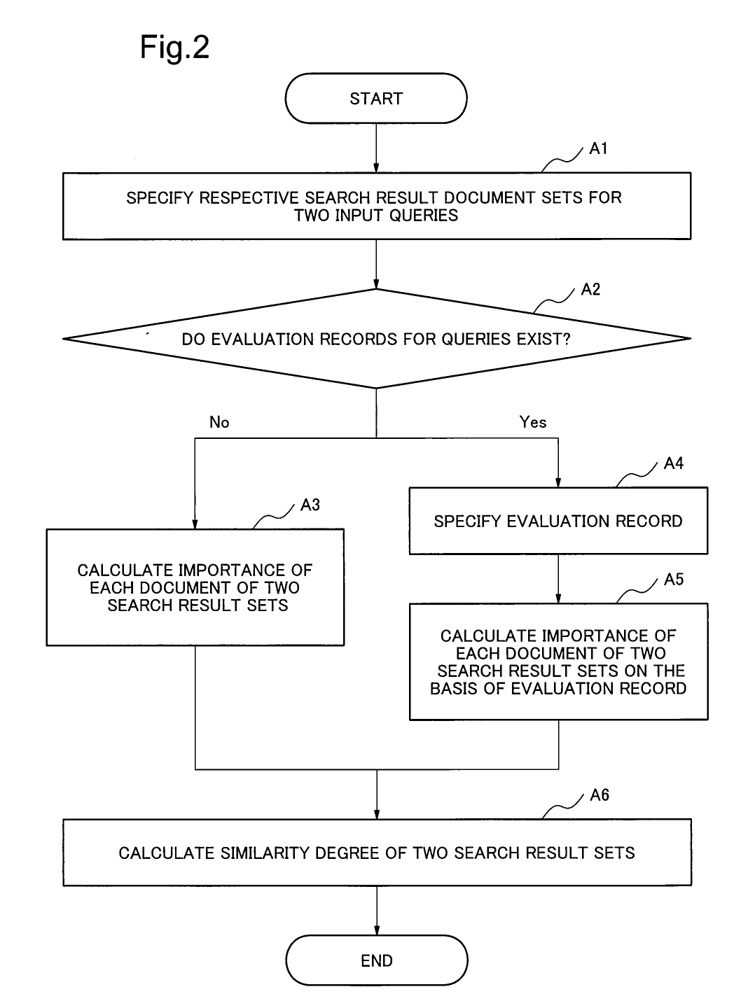

Next, Operation of the query similarity-degree evaluation system in the exemplary embodiment of the present invention is described, with appropriate reference to FIG. 1, by using FIG. 2. In the exemplary embodiment of the present invention, the query similarity-degree evaluation system is operated to perform a query similarity-degree evaluation method. For this reason, description of the query similarity-degree evaluation method in the exemplary embodiment of the present invention is substituted for the following description of the operation of the query similarity-degree evaluation system.

Next, entire operation of the query similarity-degree evaluation system in the exemplary embodiment of the present invention is described with reference to FIG. 2. FIG. 2 is a flowchart representing a process of the query similarity-degree evaluation system according to the exemplary embodiment of the present invention.

First, the search result acquisition unit 21 specifies search result document sets for two queries from the search target document storing unit 31, and outputs the two queries and the search result document sets for the respective queries to the search result ranking unit 22 (step A1).

Next, the search result ranking unit 22 determines whether or not evaluation records exist in the query evaluation record storing unit 32 for the two queries and the respective search results at the step A1. When the evaluation records exist in the query evaluation record storing unit 32, the process advances to the step A4. When the evaluation records do not exist in the query evaluation record storing unit 32, the process advances to the step A3 (step A2).

Next, the search result ranking unit 22 calculates importance for the two queries and the search result document sets corresponding to the respective queries at the step A1 (step A3). For example, the search result ranking unit 22 rearranges search results for the two queries and the search result document sets corresponding to the respective queries at the step A1.

Next, the search result ranking unit 22 specifies the evaluation records existing in the query evaluation record storing unit 32 for the two queries and the search result document sets corresponding to the respective queries at the step A1 (step A4).

Next, for the evaluation records specified at the step A4, the queries, and the search result document sets corresponding to the queries, the search result ranking unit 22 calculates a importance for each document for the two search result document sets corresponding to the queries such that a importance for a document more highly evaluated in the evaluation record becomes higher. When the evaluation record of each document of the two is specified, the search result ranking unit 22 calculates two kinds of importance. The search result ranking unit 22 outputs, one group or two groups of the two search result document sets for which importance have been calculated on the basis of the respective evaluation records, to the query similarity-degree calculation unit 23 (step A5).

Next, for the one group or the two groups of the two search result document sets at the step A3 to the step A5, the query similarity-degree calculation unit 23 calculates a similarity degree so as to place importance on similarity between documents having larger importance. When the two groups of the two search result document sets are output, the query similarity-degree calculation unit 23 outputs an average of the similarity degrees of the respective groups (step A6).

[Program]

A program of the query similarity-degree evaluation system in the exemplary embodiment of the present invention only needs to cause a computer to perform the steps A1 to A6 illustrated in FIG. 2. By introducing this program to the computer and by executing it, the query similarity-degree evaluation system in the exemplary embodiment of the present invention and the query similarity-degree evaluation method can be implemented.

[Computer]

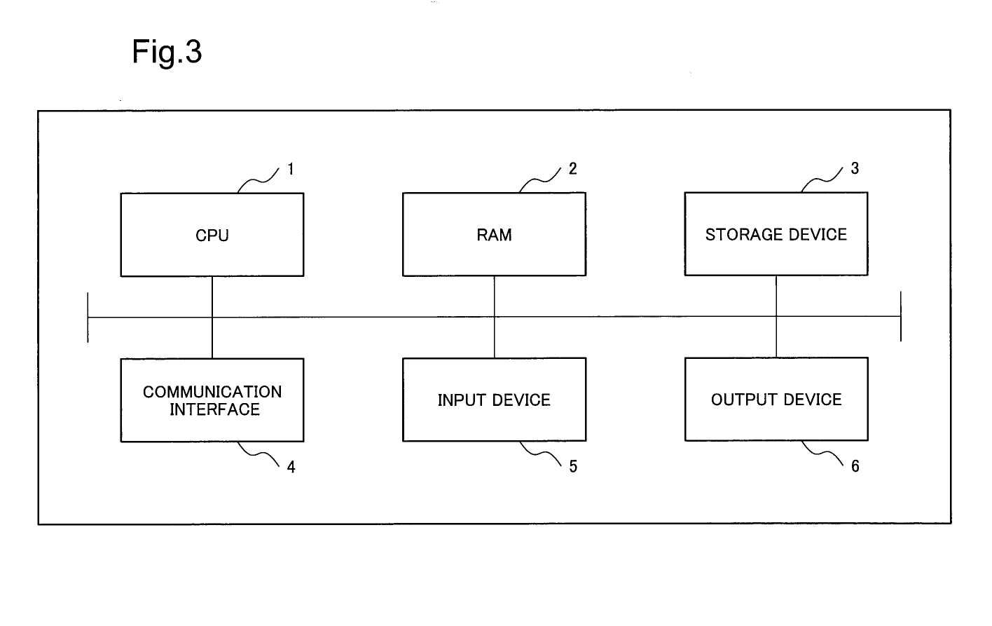

By using FIG. 3, a computer that realizes the query similarity-degree evaluation system in the exemplary embodiment of the present invention is described. FIG. 3 is a block diagram illustrating one example of the computer that realizes a configuration of the exemplary embodiment of the present invention.

FIG. 3 is a hardware configuration diagram of the query similarity-degree evaluation system in the exemplary embodiment of the present invention. As illustrated in FIG. 3, the query similarity-degree evaluation system includes a central processing unit (CPU) 1, a random access memory (RAM) 2, a storage device 3, a communication interface 4, an input device 5, an output device 6, and the like, for example.

The CPU 1 reads out the program to the RAM 2 to execute the program so that the search result acquisition unit 21, the search result ranking unit 22, and the like are practiced. An application program controls the communication interface 4 by using a function provided by an operating system (OS), e.g., to practice operation of transmission and reception of information performed by the search result acquisition unit 21, the search result ranking unit 22, and the like. The storage device 3 is a hard disk or a flash memory, for example. The input device 5 is a keyboard, a mouse, or the like, for example. The output device 6 is a display or the like, for example.

Operation of the exemplary embodiment of the present invention is described by using a concrete example.

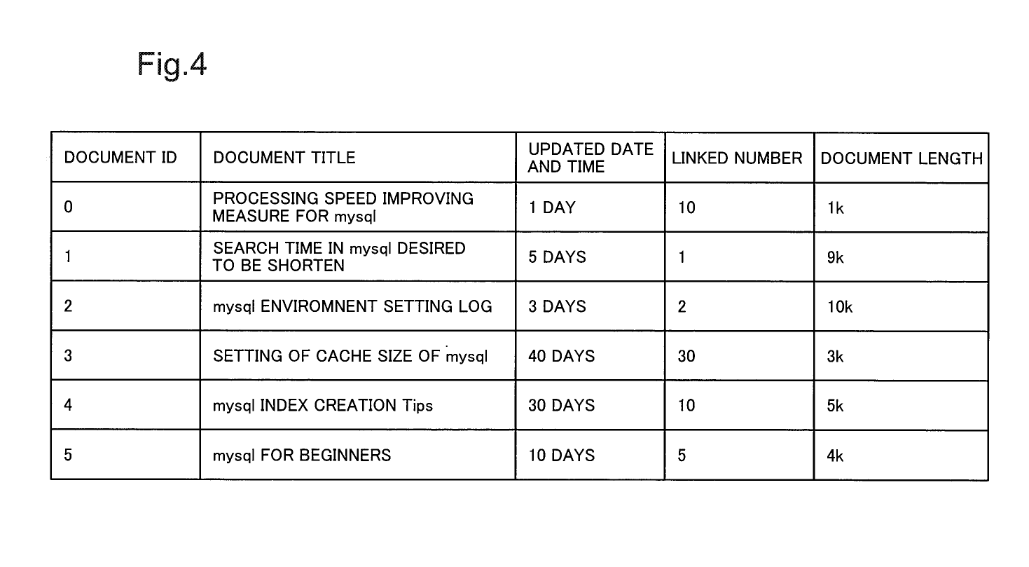

As illustrated in FIG. 4, the search target document storing unit 31 stores search target document data. The search target document data illustrated in FIG. 4 represents a data set of six respective documents in an example. For example, the search target document data is a data set of IDs of documents, titles of the documents, the numbers of days that have elapsed from updated dates and time of the documents to the present time, the linked numbers of the documents, lengths (word numbers) of the documents, and the like.

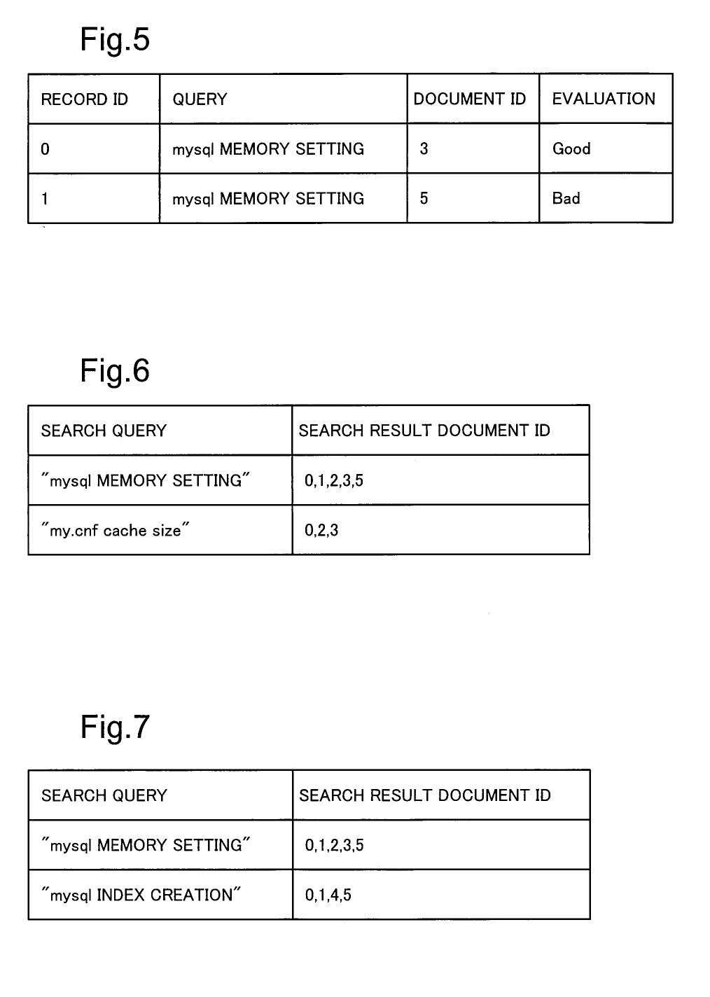

As illustrated in FIG. 5, the query evaluation record storing unit 32 stores queries and evaluation records (query evaluation records) corresponding to the queries.

The query evaluation records illustrated in FIG. 5 are a data set of queries, IDs of the evaluated documents, evaluation contents (“Good” indicates the same as a search target document, and “Bad” indicates difference from the search target document), and the like for one-time evaluation performed when searching is performed by inputting the query “mysql memory setting”, for example.

In the following, a concrete process in calculation of a query similarity degree is described for a case (case 1) where two queries of “mysql memory setting” and “my.cnf cache size” are input and a case (case 2) where two queries of “mysql memory setting” and “mysql index creation” are input.

In the case 1, a purpose of each of queries is to search for a setting method regarding a memory of mysql, and the search intention thereof is similar to each other. In the case 2, a purpose of “mysql memory setting” is to search for a setting method of a memory, and a purpose of “mysql index creation” is a creating method of an index of a field, so that the search intention thereof is different from each other. However, each of the queries in the case 2 is a method for increasing a processing speed, so that the description can be included in the same document.

First, the search result acquisition unit 21 refers to the search target document storing unit 31 and specifies documents retrieved by the respective queries. For example, as illustrated in FIG. 6, in the case 1, for example, the search result acquisition unit 21 specifies documents whose texts include the query, specifies the documents of the document IDs of 0, 1, 2, 3, and 5 as a search result for the query “mysql memory setting”, and specifies the documents of the document IDs of 0, 2, and 3 as a search result for the query “my.cnf cache size”.

As illustrated in FIG. 7, for example, in the case 2, the search result acquisition unit 21 specifies the documents of the document IDs of 0, 1, 2, 3, and 5 as a search result for the query “mysql memory setting”, and specifies the documents of the document IDs of 0, 1, 4, and 5 as a search result for the query “mysql index creation”. The search result acquisition unit 21 outputs the respective queries and sets of the search result document IDs to the search result ranking unit 22.

Next, the search result ranking unit 22 refers to the query evaluation record storing unit 32 and specifies existence of only evaluation records of “mysql memory setting” out of the two queries output by the search result acquisition unit 21, for both of the case 1 and the case 2.

The evaluation records for the completely same queries are used as this concrete example. However, in the following concrete process at the time of calculating a query similarity degree, the query may be decomposed into keywords (e.g., “mysql memory setting” is decomposed into “mysql”, “memory”, and “setting”) to use evaluation records including the keywords.

Next, on the basis of evaluation records (evaluation record IDs of 0 and 1) of the query “mysql memory heavy” for which evaluation records exist, the search result ranking unit 22 performs ranking of the two output search results such that a importance of the document of the document ID of 3 that has been evaluated high (evaluated as “Good”) in the evaluation record is high, and a importance of the document of the document ID of 5 that has been evaluated low (evaluated as “Bad”) in the evaluation record is low.

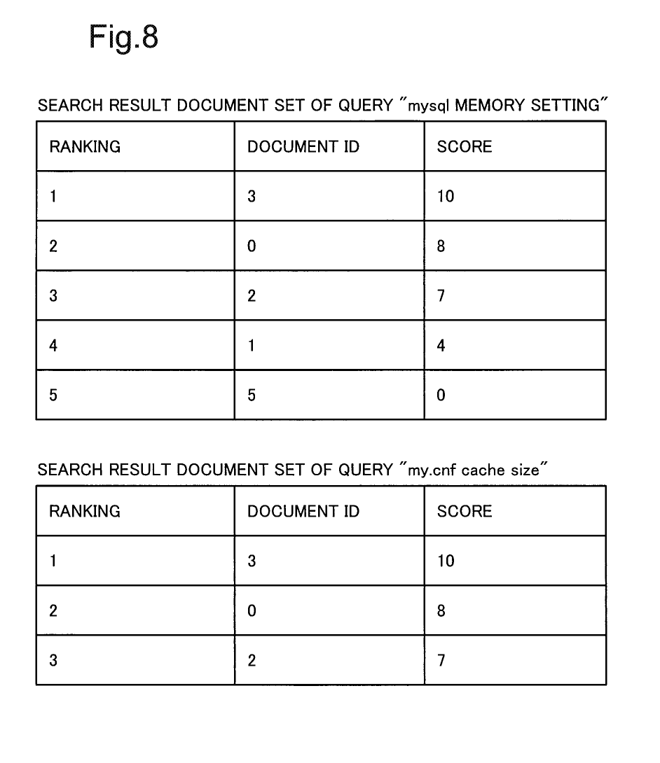

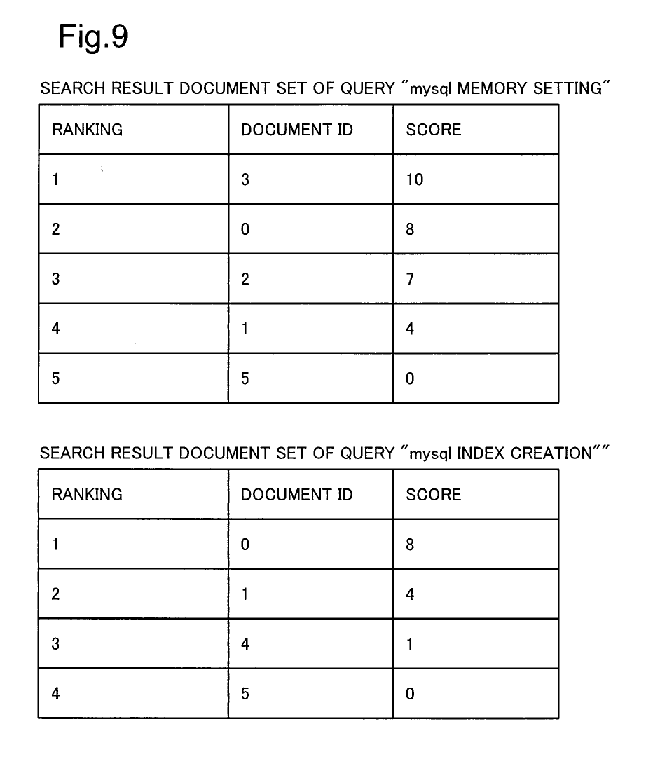

For example, the search result ranking unit 22 specifies the words “buffer”, “pool”, and “set file”, as characteristic words, whose frequencies are high in the high-evaluated document of the document ID of 3, and are low in the low-evaluated document of the document ID of 5, and calculates the sum of the appearance frequencies of “buffer”, “pool”, and “set file” in the text as an importance. Then, as illustrated in FIG. 8, for example, in the case 1, the search result ranking unit 22 obtains ranking results such as rankings, document IDs, scores, and the like for the search result document set of the query “mysql memory setting” and the search result document set of the query “my.cnf cache size”. As illustrated in FIG. 9, for example, in the case 2, the search result ranking unit 22 obtains ranking results such as rankings, document IDs, scores, and the like for the search result document set of the query “mysql memory setting” and the search result document set of the query “mysql index creation”.

As an evaluation method of the search result ranking unit 22, however, a word frequently used may be specified only in low-evaluated documents and larger importance may be calculated as a frequency of the word concerned is lower. Alternatively, as an evaluation method of the search result ranking unit 22, metadata is used, a score of a high-evaluated document is set as +1, and a score of a low-evaluated document is set as −1, a function of outputting a score from metadata (e.g., updated date and time, the linked number, and a length of a document) is learned, and a value output by the function is determined as a importance.

A importance of a document d in a search result S is calculated by using a ranking order(d) in the search result S as follows. A importance of a document d₁ in the search result S₁ is calculated by using a ranking order₁(d), and a importance of a document d₂ in the search result S₂ is calculated by using a ranking order₂(d).

$$w ( d ) = \frac{{e}^{- order ( d )}}{{\sum }_{d ∈ S} {e}^{- order ( d )}} \qquad [ Equation 3 ]$$

A query similarity degree based on importance of documents is calculated as follows.

$$\begin{matrix}\frac{{\sum }_{d ∈ {S}_{1} ⋂ {S}_{2}} {w}_{1} ( d ) {w}_{2} ( d )}{min ( {\sum }_{d ∈ {S}_{1}} {{w}_{1} ( d )}^{2} , {\sum }_{d ∈ {S}_{2}} {{w}_{2} ( d )}^{2} )} & [ Equation 4 ] \\ \frac{{\sum }_{d ∈ {S}_{1} ⋂ {S}_{2}} {e}^{- ( {order}_{1} ( d ) + {order}_{2} ( d ) )}}{{\sum }_{i = 1}^{min} ( \vert {S}_{1} \vert , \vert {S}_{2} \vert ) {e}^{- 2 i}} & [ Equation 5 ]\end{matrix}$$

The equation 5 is obtained by substituting the equation 3 into the equation 4.

Next, the query similarity-degree calculation unit 23 calculates a similarity degree as follows by using input of two search result documents that are input from the search result ranking unit 22 and to which importance of FIG. 8 or FIG. 9 are given.

$$\frac{{e}^{- ( 1 + 1 )} + {e}^{- ( 2 + 2 )} + {e}^{- ( 3 + 3 )}}{{\sum }_{i = 1}^{3} {e}^{- 2 i}} = \frac{0.1561}{0.1561} = 1.0 \qquad [ Equation 6 ]$$

In the case 1, the query similarity-degree calculation unit 23 outputs a calculated result of 1.0 as in the equation 6.

$$\frac{{e}^{- ( 2 + 1 )} + {e}^{- ( 4 + 2 )} + {e}^{- ( 5 + 4 )}}{{\sum }_{i = 1}^{4} {e}^{- 2 i}} = \frac{0.0524}{0.1565} = 0.335 \qquad [ Equation 7 ]$$

In the case 2, the query similarity-degree calculation unit 23 outputs a calculated result of 0.335 as in the equation 7.

In a conventional method, in the case 1, rates of the common documents in the search results are 3/5 and 3/3 at the respective search results, and an average of them is 0.8, and in the case 2, rates of the common documents in the search results are 3/5 and 3/4 at the respective search results, and an average of them is 0.675, and a large similarity degree is calculated for the queries whose search intention is different from each other.

Meanwhile, in the exemplary embodiment of the present invention, in the case 1 of the same search intention, a similarity degree of 1.0 is calculated, and in the case 2 of the different search intention, a similarity degree of 0.335 is calculated, and thus, a smaller similarity degree can be calculated for the queries whose search intention is different from each other.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A part or all of the above-described exemplary embodiment can be described as in the following supplementary notes, and however, are not limited to the following. This application claims priority based on Japanese patent application No. 2012-217118 filed on Sep. 28, 2012, of which disclosure is entirely incorporated herein.

### INDUSTRIAL APPLICABILITY

The present invention can be applied to use in a query recommendation system, a document ranking system, or the like.

### REFERENCE SIGNS LIST

1 CPU
2 RAM
3 Storage device
4 Communication interface
5 Input device
6 Output device
21 Search result acquisition unit
22 Search result ranking unit
23 Query similarity-degree calculation unit
31 Search target document storing unit
32 Query evaluation record storing unit

What is claimed is:

1. A query similarity-degree evaluation system comprising:
a search result ranking unit that determines a first weight degree of each of a plurality of documents on the basis of respective evaluation results of the plurality of documents that have been retrieved by a first query, and determining a second weight degree of each of a plurality of documents on the basis of respective evaluation results of the plurality of documents that have been retrieved by a second query; and
a query similarity-degree calculation unit that calculates a similarity-degree of the queries on the basis of the first and second importance of the respective documents of the document sets.

2. The query similarity-degree evaluation system according to claim 1, wherein
when evaluating a similarity degree of a plurality of queries including at least the first query and the second query, the search result ranking unit calculates importance of each document included in the document set concerned by comparing a current document set with an evaluation result of a past document set of the query, for each of the document sets of results obtained by the respective queries.

3. The query similarity-degree evaluation system according to claim 1, wherein
the search result ranking unit specifies respective characteristic words for the high-evaluated document and the low-evaluated document, and the query similarity-degree calculation unit calculates a high weight degree for the document in which an appearance frequency of the characteristic word of the high-evaluated document is high, and calculates a low weight degree for the document in which an appearance frequency of the characteristic word of the low-evaluated document is high.

4. The query similarity-degree evaluation system according to claim 1, wherein
The search result ranking unit refers to metadata given to the high-evaluated document and the low-evaluated document respectively, calculates a higher weight degree for the document having a value of metadata that is closer to a value of the metadata of the high-evaluated document, and calculates a lower weight degree for the document having the metadata that is closer to a value of metadata of the low-evaluated document.

5. The query similarity-degree evaluation system according to claim 1, wherein
when a search result set 1 is S₁, a search result set 2 is S₂, importance (normalized such that the sum for documents in the search result set 1 becomes 1) of document d in the search result set 1 is w₁(d), importance of the document d in the search result set 2 is w₂(d), and a similarity degree between the document d₁ and the document d₂ is sim(d₁, d₂), the query similarity-degree calculation unit uses algorithm:
$${\sum }_{{d}_{1} ∈ {S}_{1}} {\sum }_{{d}_{2} ∈ {S}_{2}} {w}_{1} ( {d}_{1} ) {w}_{2} ( {d}_{2} ) sim ( {d}_{1} , {d}_{2} ) , \qquad [ Equation 1 ]$$
to calculate a query similarity degree.

6. A query similarity-degree evaluation method comprising:
ranking a search result by determining importance of each of a plurality of documents on the basis of respective evaluation results of the plurality of documents that have been retrieved by a first query, and by determining importance of each of a plurality of documents on the basis of respective evaluation results of the plurality of documents that have been retrieved by a second query; and
calculating a query similarity degree by calculating a similarity-degree of the queries on the basis of first and second importance of the respective documents of the document sets.

7. The query similarity-degree evaluation method according to claim 6, wherein
during the search result ranking, when evaluating a similarity degree of a plurality of queries including at least the first query and the second query, calculating importance of each document included in the document set concerned by comparing the current document set with an evaluation result of a past document set of the query, for each of the document sets of results obtained by the respective queries.

8. The query similarity-degree evaluation method according to claim 6, wherein
during the search result ranking, specifying respective characteristic words for high-evaluated document and low-evaluated document, and calculating a high weight degree for the document in which an appearance frequency of the characteristic word of the high-evaluated document is high, and calculating a low weight degree for the document in which an appearance frequency of the characteristic word of the low-evaluated document is high.

9. The query similarity-degree evaluation method according to claim 6, wherein
during the search result ranking, referring to metadata given to the high-evaluated document and the low-evaluated document respectively, calculates a higher weight degree for the document having a value of the metadata that is closer to a value of metadata of the high-evaluated document, and calculating a lower weight degree for the document having the metadata that is closer to a value of metadata of the low-evaluated document.

10. A non-transitory computer-readable storage medium storing a program for calculating a query similarity-degree, wherein the program causes a computer to perform:
determining a first weight degree of each of a plurality of documents on the basis of respective evaluation results of the plurality of documents that have been retrieved by a first query;
determining a second weight degree of each of a plurality of documents on the basis of respective evaluation results of the plurality of documents that have been retrieved by a second query; and
calculating a similarity-degree of the queries on the basis of the first and second importance of the respective documents of the document sets.
